(19) United States
(12) Patent Application Publication
(10) Pub. No.: US 2014/0003637 A1
(43) Pub. Date: Jan. 2, 2014

(54) INFRARED SENSORS FOR HEARING ASSISTANCE DEVICES

(71) Applicant: Thomas Howard Burns, St. Louis Park, MN (US)

(72) Inventor: Thomas Howard Burns, St. Louis Park, MN (US)

(73) Assignee: Starkey Laboratories, Inc., Eden Prairie, MN (US)

(21) Appl. No.: 13/536,279

(22) Filed: Jun. 28, 2012

(51) Int. Cl. H04R 25/00

(52) U.S. Cl. 381/314

(57) ABSTRACT

Disclosed herein, among other things, are apparatus and methods for infrared sensors on hearing assistance devices. In various embodiments, a hearing assistance device includes a housing, hearing assistance electronics within the housing, and an infrared sensor connected to the hearing assistance electronics. The infrared sensor is configured to detect proximity or touch by the wearer to control the hearing assistance device, in various embodiments. In one embodiment, the sensor circuit is configured to detect the wearer when the housing is worn.

### TECHNICAL FIELD

This document relates generally to hearing assistance systems and more particularly to a hearing assistance device with one or more infrared sensors.

### BACKGROUND

Hearing assistance devices are used to assist patient's suffering hearing loss by transmitting amplified sounds to ear canals. In one example, a hearing aid is worn in and/or around a patient's ear. Patients prefer that their hearing aids are minimally visible or invisible, do not interfere with their daily activities, and are easy for them to control during use, such as pairing the device with an external programmer, turning the device on/off and adjusting sound volume. One area of particular concern is how to operate hearing aid devices in view of shrinking package sizes, limited power, and an increasingly more adult population with limited or diminishing manual dexterity.

Accordingly, there is a need in the art for improved switching and sensing for hearing assistance devices.

### SUMMARY

Disclosed herein, among other things, are apparatus and methods for infrared sensors on hearing assistance devices. In various embodiments, a hearing assistance device includes a housing, hearing assistance electronics within the housing, and an infrared sensor connected to the hearing assistance electronics. The infrared sensor is configured to detect proximity or touch by the wearer to control the hearing assistance device, in various embodiments. In one embodiment, the infrared sensor is configured to detect the wearer when the housing is worn.

This Summary is an overview of some of the teachings of the present application and not intended to be an exclusive or exhaustive treatment of the present subject matter. Further details about the present subject matter are found in the detailed description and appended claims. The scope of the present invention is defined by the appended claims and their legal equivalents.

### BRIEF DESCRIPTION OF THE DRAWINGS

FIGS. 1A-1B illustrate a behind-the-ear hearing assistance device with an infrared sensor, according to various embodiments of the present subject matter.

FIG. 2 illustrates an in-the-ear hearing assistance device with an infrared sensor, according to various embodiments of the present subject matter.

FIG. 3 illustrates an in-the-ear hearing assistance device with an infrared sensor for an automatic on-off feature, according to various embodiments of the present subject matter.

FIGS. 4A-4B illustrate a behind-the-ear hearing assistance device with an infrared sensor for an automatic on-off feature, according to various embodiments of the present subject matter.

FIGS. 5A-5B illustrate an in-the-ear hearing assistance device with multiple infrared sensors, according to various embodiments of the present subject matter.

### DETAILED DESCRIPTION

The following detailed description of the present subject matter refers to subject matter in the accompanying drawings which show, by way of illustration, specific aspects and embodiments in which the present subject matter may be practiced. These embodiments are described in sufficient detail to enable those skilled in the art to practice the present subject matter. References to “an”, “one”, or “various” embodiments in this disclosure are not necessarily to the same embodiment, and such references contemplate more than one embodiment. The following detailed description is demonstrative and not to be taken in a limiting sense. The scope of the present subject matter is defined by the appended claims, along with the full scope of legal equivalents to which such claims are entitled.

The present detailed description will discuss hearing assistance devices using the example of hearing aids. Hearing aids are only one type of hearing assistance device. Other hearing assistance devices include, but are not limited to, those in this document. It is understood that their use in the description is intended to demonstrate the present subject matter, but not in a limited or exclusive or exhaustive sense.

Hearing aids typically include a housing or shell with internal components such as a microphone, electronics and a speaker. Patients prefer that their hearing aids are minimally visible or invisible, do not interfere with their daily activities, and easy for them to control during use. It is common for an elderly user of a hearing assistive device to have poor manual dexterity. There is a desire, therefore, to have smart functionality in the form of momentary switching, on/off detection, and volume control, thereby requiring less effort by the user. It would be advantageous to perform this smart functionality with a small form factor, with low electrical power consumption, without the need to touch a specific location on the hearing device, and from within the hearing device without any physical penetrations through the exterior plastic housing. Physical penetrations of the housing provide potential paths for moisture and debris ingress, which can affect device performance and longevity.

Disclosed herein, among other things, are apparatus and methods for user interface sensors on hearing assistance devices. In various embodiments, a hearing assistance device includes a housing, a hearing assistance circuit within the housing, and a sensor circuit connected to the hearing assistance circuit. The sensor circuit is configured to detect proximity or touch by the wearer to control the hearing assistance device, in various embodiments.

The present subject matter provides an infrared sensor or an array of infrared sensors as a momentary switch, a volume control, or a power on/off switch in a hearing assistive device. The infrared sensor/switch does not require physical contact with the user in order to be triggered. In addition, it can sense infrared light through the commodity plastics typically used in the housings of hearing instruments, thus, it can be integrated into the device without any seams, cracks, or penetrations, and still maintain a relatively high range of detection. Benefits of the present subject matter include, but are not limited to: 1) the chip scale electronics for the photodiode array are smaller than today's capacitive switch electronics; 2) the sensor can be integrated inside the device and sense infrared energy reflected from objects moving directly outside the housing; objects moving outside the device, i.e., a finger for example, do not need to contact the sensor directly; and the proximity range for IR detection is much greater than the detection range for capacitive sensing.

According to various embodiments, infrared (IR) sensor systems operate by digitizing the output signal(s) from a photodiode array, thereby converting IR light of a desired spectral response (typically wavelengths on the order of 500 nm to 850 nm) into an output current. These systems can also contain an IR light emitting diode (LED) and operate as a proximity sensor, in various embodiments. As such, the LED is driven to emit IR; if the IR emission encounters an object and reflects back, it is collected and digitized by the photodiode array. The magnitude of the digitized output is proportional to distance of the object. If two photodiode arrays are positioned on opposite sides of an IR LED and each photodiode array is operated as a proximity sensor, the two output signals can be processed by summation, subtraction, differentiation, etc., in order to estimate the motion of an object. For example, finger motion over the array could be processed to determine which direction the finger was swiped, thereby controlling, for example, an increase or decrease in the volume of the hearing instrument.

When operated passively as an ambient light sensor (ALS) detecting wavelengths in the range of approximately 550 nanometers, a photodiode array could be integrated into the medial tip of a custom hearing instrument, according to various embodiments. When the instrument is placed in the ear canal, the reception of ambient IR light is reduced and the hearing instrument is turned on, in an embodiment. Similarly, an ALS could be integrated with an IR LED in an embodiment to operate actively as a proximity sensor, and also integrated into the medial tip of a custom hearing instrument. When the instrument is placed in the ear canal, the IRLED/ALS system is duty-cycled to detect the ear canal boundaries and the hearing instrument is turned on, in an embodiment. Conversely, the hearing instrument is turned off when the proximity IRLED/ALS system does not detect the ear canal boundaries, in various embodiments. The ON/OFF functionality can also be integrated into a standard hearing instrument provided that an appropriate location is used for the IRLED and/or ALS detection when the instrument is positioned in-situ. According to various embodiments, this location would be on the underside of the hearing instrument so that it is sufficiently shielded from light when worn by the user, or that the boundaries of the head or pinna could be detected actively.

Another embodiment for a hearing instrument, when operated actively as a proximity IRLED/ALS system as described previously, is a momentary switch. For example, the swipe of a finger could be detected to change the memory settings. Using a detection algorithm, the direction of the finger swipe is detected to control an increase or decrease in volume, in an embodiment. Alternatively, an IRLED could be positioned between two ambient light sensors, thereby creating an array of ALS photodiodes, in another embodiment. Reflections from the IRLED are detected at two locations such that the motion of a finger would produce a temporal difference in the two ALS output signals, thereby providing a simpler method for signal detection. For example, the difference of the two output signals may have characteristics that are better correlated to the direction of a finger swipe as compared to the straight output of a single ALS. Similarly, the time derivative of the aforementioned difference in outputs contain characteristics with even better correlation to the swipe direction than the difference signal itself, in an embodiment.

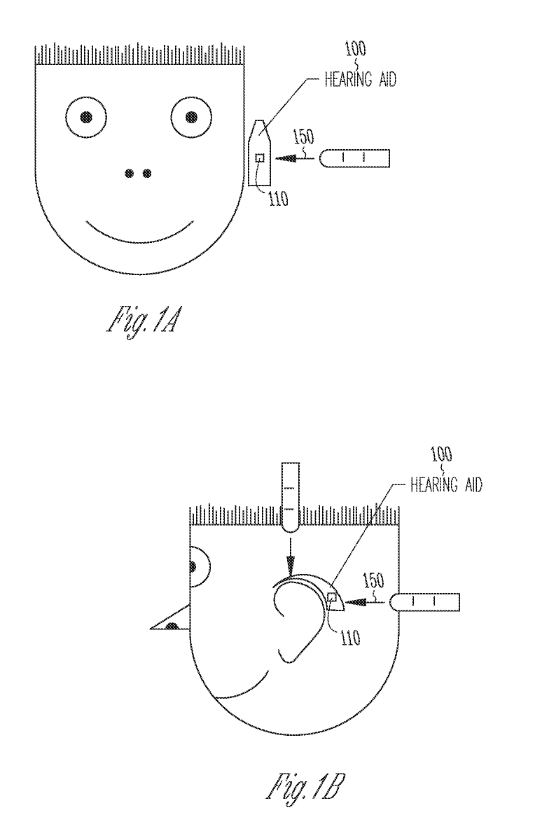

FIGS. 1A-1B illustrate a behind-the-ear hearing assistance device 100 with an infrared sensor 110, according to various embodiments of the present subject matter. By “tapping” or “swiping” at appropriate locations on or near the device using a wearer's finger 150, volume changes and memory changes can be performed, for example. Other functions and parameter changes can be performed without departing from the scope of this disclosure. For example, an estimate of dynamic acoustical headroom is typically continuously computed in a hearing instrument. The IR signal output can be compared to the acoustical headroom estimate, in an embodiment. If the hearing instrument is taken out of the wearer's ear, acoustical headroom will be reduced. That observation, together with, for example, an abrupt change in the IR sensor output, can be used to control ON/OFF functionality for the instrument in various embodiments.

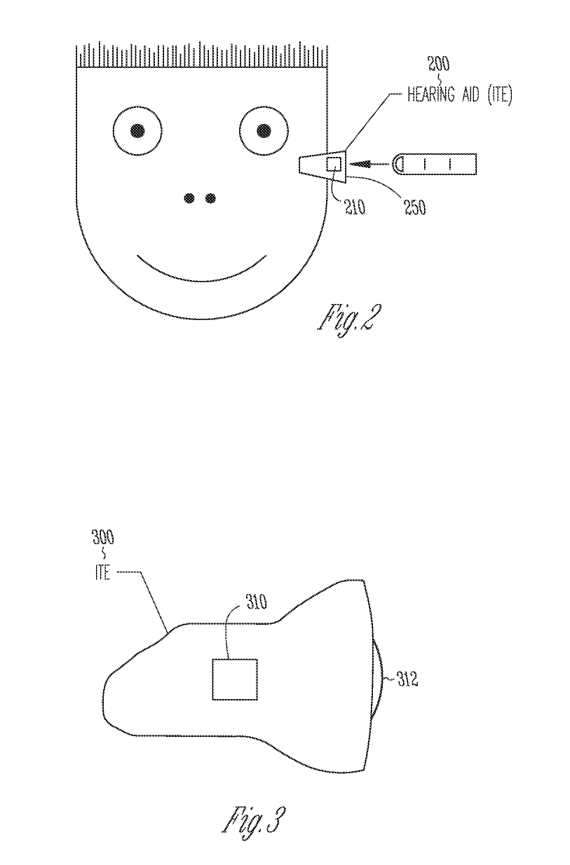

The infrared sensor can also be used with in-the-ear (ITE) devices. As shown in FIG. 2, a tapping or swiping action with a finger 250 on or near the surface of the ITE hearing device 200 can be detected by an infrared sensor 210 and processed. For ITE devices, especially completely-in-canal (CIC) formats, it is difficult to incorporate traditional electromechanical sensor components because of surface area and volume constraints. As a result, the user ends up with limited control over their hearing device They are forced into using only one memory program, with no ability to alter loudness, and no way to place the device into telecoil mode for improved telephone performance. Benefits of the infrared sensor include freedom of placement within the hearing device and resistance to water and moisture.

FIG. 3 illustrates an in-the-ear hearing assistance device 300 with an infrared sensor 310 for an automatic on-off feature, according to various embodiments of the present subject matter. In various embodiments, a second infrared sensor 312 is used for the automatic on-off feature. In various embodiments, the automatic on-off feature involves sensing whether the device 300 is in an ear canal. For example, if the device 300 is sensed to be in the canal then it is turned on. When the ITE device 300 (or ear piece of a BTE, in an embodiment) is placed in the ear canal, the infrared sensor 310 or 312 is activated to turn on the device.

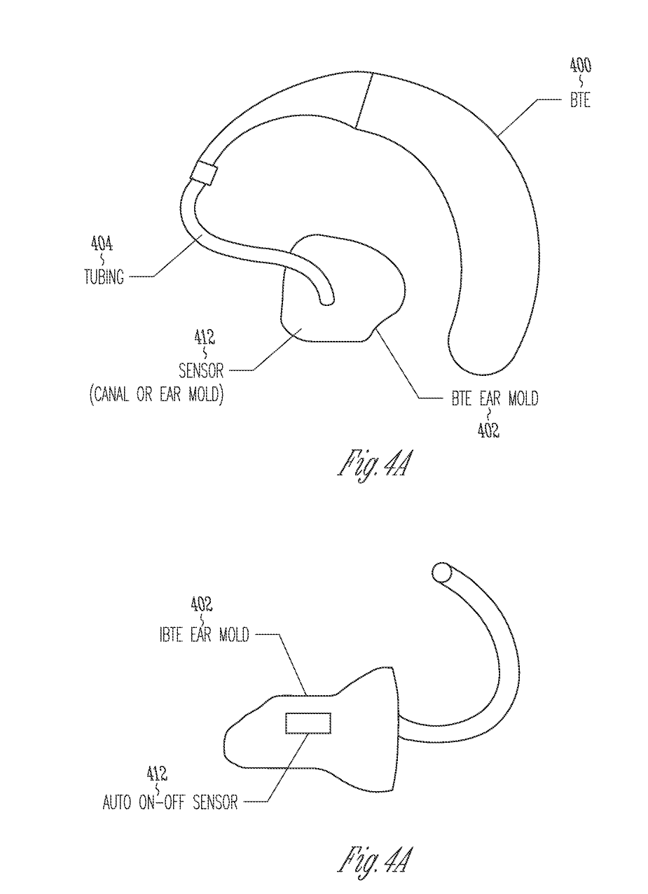

FIG. 4A-4B illustrates automatic on-off implementation for a BTE device 400. The device 400 includes an ear mold 402 connected using tubing 404, in various embodiments. According to various embodiments, the ear mold 402 includes an infrared sensor 412 to sense wither the ear mold 402 is in a wearer's ear canal. The present subject matter is applicable to conventional BTE ear molds or “open” ear designs, in various embodiments.

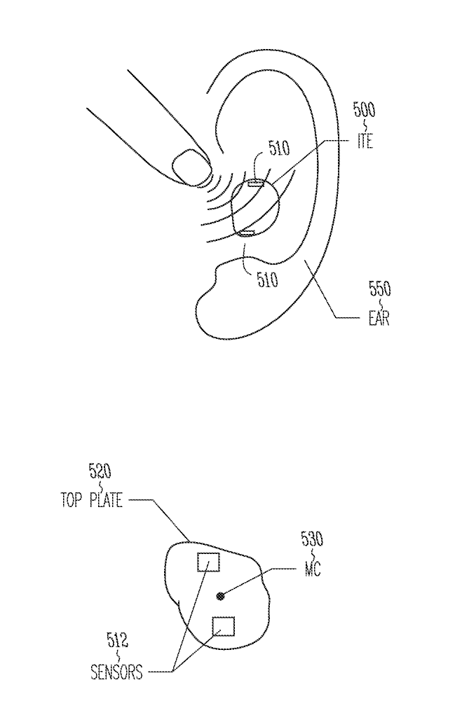

FIGS. 5A-5B illustrate an in-the-ear hearing assistance device with multiple infrared sensors, according to various embodiments of the present subject matter. In FIG. 5A, the housing of device 500 in ear 550 includes two infrared sensors 512. More infrared sensors can be used without departing from the scope of this disclosure. In FIG. 5B, multiple infrared sensors 512 are located within the top plate 520 of the device housing. A microphone port 530 is included in the top plate of the housing, in an embodiment.

It is further understood that any hearing assistance device may be used without departing from the scope and the devices depicted in the figures are intended to demonstrate the subject matter, but not in a limited, exhaustive, or exclusive sense. It is also understood that the present subject matter can be used with a device designed for use in the right ear or the left ear or both ears of the wearer.

The present subject matter is demonstrated for hearing assistance devices, including hearing aids, including but not limited to, behind-the-ear (BTE), in-the-ear (ITE), in-the-canal (ITC), receiver-in-canal (RIC), or completely-in-the-canal (CIC) type hearing aids. It is understood that behind-the-ear type hearing aids may include devices that reside substantially behind the ear or over the ear. Such devices may include hearing aids with receivers associated with the electronics portion of the behind-the-ear device, or hearing aids of the type having receivers in the ear canal of the user, including but not limited to receiver-in-canal (RIC) or receiver-in-the-ear (RITE) designs. The present subject matter can also be used in hearing assistance devices generally, such as cochlear implant type hearing devices and such as deep insertion devices having a transducer, such as a receiver or microphone, whether custom fitted, standard, open fitted or occlusive fitted. It is understood that other hearing assistance devices not expressly stated herein may be used in conjunction with the present subject matter.

This application is intended to cover adaptations or variations of the present subject matter. It is to be understood that the above description is intended to be illustrative, and not restrictive. The scope of the present subject matter should be determined with reference to the appended claims, along with the full scope of legal equivalents to which such claims are entitled.

What is claimed is:

1. A hearing assistance device for a wearer, comprising:
a housing;
hearing assistance electronics within the housing; and
an infrared sensor coupled to the hearing assistance electronics, wherein the infrared sensor is configured to detect proximity or touch by the wearer.

2. The device of claim 1, wherein the infrared sensor is configured to switch upon detection of proximity or touch.

3. The device of claim 2, wherein the infrared sensor is adapted to control one or more functions of the hearing assistance electronics.

4. The device of claim 2, wherein the infrared sensor is adapted to turn the device on and off.

5. The device of claim 1, wherein the housing is adapted to mount in or about an ear of a person.

6. The device of claim 1, wherein the hearing assistance electronics include a wireless communication unit.

7. The device of claim 1, wherein further comprising an array of infrared sensors.

8. The device of claim 7, wherein the array of infrared sensors includes a photodiode array.

9. The device of claim 1, wherein the infrared sensor includes a light emitting diode (LED).

10. The device of claim 1, wherein the infrared sensor is adapted to determine a direction of a swipe by the wearer's finger.

11. A hearing assistance device for a wearer, the device comprising:
a housing; and
hearing assistance electronics housed in the housing;
an infrared sensing switch connected to the hearing assistance electronics, the infrared sensing switch adapted to detect the wearer when the housing is worn.

12. The device of claim 11, wherein the hearing electronics are adapted to automatically turn “off” when the infrared sensing switch fails to detect the wearer.

13. The device of claim 12, wherein the hearing electronics are adapted to automatically turn “off” a predetermined interval of time after the infrared sensing switch fails to detect the wearer.

14. The device of claim 11, further comprising a second infrared sensing switch connected to the hearing assistance electronics and adapted to generate a switch signal when touched.

15. The device of claim 14, wherein the hearing assistance electronics are adapted to adjust a volume of the hearing assistance electronics in response to the switch signal.

16. The device of claim 14, further comprising at least one additional infrared sensing switch, wherein the hearing assistance electronics are adapted to execute a function when the second infrared sensing switch and the at least one additional infrared sensing switch are triggered according to a predetermined sequence.

17. The device of claim 11, wherein the housing includes an in-the-ear (ITE) hearing aid housing.

18. The device of claim 11, wherein the infrared sensing switch includes an ambient light sensor (ALS).

19. The device of claim 17, wherein the infrared sensing switch is configured to detect ear canal boundaries.

20. The device of claim 11, wherein the housing includes a behind-the-ear (BTE) housing.
